(19) United States
(12) Patent Application Publication
(10) Pub. No.: US 2003/0221857 A1
(43) Pub. Date: Dec. 4, 2003

(54) Front system comprising and intergrated eletric display element

(76) Inventors: Werner Koerber, Betzenstein (DE); Kurt Michael Schaffer, Eckental (DE); Ralf Behrens, Nurnberg (DE); Siegfried Kurrer, Nurnberg (DE)

Correspondence Address: Pauley Petersen Kinne & Erickson, 2800 West Higgins Road Suite 365, Hoffman Estates, IL, 60195, US

(21) Appl. No.: 10/344,823

(22) PCT Filed: Aug. 17, 2001
(86) PCT No.: PCT/EP01/09520

(30) Foreign Application Priority Data
Aug. 17, 2000 (DE) 200141988

(51) Int. Cl. H02G 3/14

(52) U.S. Cl. 174/66

(57) ABSTRACT

The invention relates to a front system for a flat module comprising an integrated electric display clement (28) and a lever pull handle (13) with an end piece (3) for a front system.

The invention relates to a front system for a flat module which can be inserted into a module support, having the characteristics of the preamble of claim 1, as well as to a lever pull handle with an end piece for such a front system.

A front system for a flat module group with an active-passive circuit is known from WO 96/42187, wherein the front system has an upper or a lower end element each arranged in the upper or lower front corner area. An upper or lower lever pull handle is attached to each one for inserting or removing the flat module into or out of the component support by leverage.

Means are furthermore provided with which, when the flat module has reached the state wherein it is inserted into the component support, the respective lever pull handle is fixed in place in the respective position. A switching element is integrated into the upper or lower end element, which is actuated by the respective lever pull handle when the latter is in its fixed position. It is possible by means of this to electrically clear the flat module. Possible electrical display elements which, for example, indicate the switched state of the switching element of the front system, are customarily separately integrated into the front plate of the front system, for which a separate structural space is required.

### CONFIRMATION COPY

The object of the invention is based on offering a front system having an electrical display element which is arranged in a particularly space-saving manner.

Moreover, a lever pull handle with an end element for such a front system is to be offered.

In connection with the front system, this object is attained by the features of the characterizing portion of claim 1, together with the features of the preamble. Advantageous embodiments of the invention are realized in dependent claims 2 to 12. In connection with the lever pull handle, the object is attained by the characteristics of claim 13.

The upper or lower end element of the front system in accordance with the invention, which is arranged in the upper or lower end area of the flat module, has an electrical display element. It is possible by means of this, for example, to indicate the switched state of the switching element integrated into the end element. In contrast to the described prior art, the front system in accordance with the invention does not require a separate structural space, for example in the front plate of the front system. In accordance with the invention, the electrical display element is housed in a space-saving and compact manner at the end element of the front system.

The display element can be connected with the end element in a number of ways and can be attached, for example, in the shape of a module or as a complementary component, to the exterior of the end element.

A solution which is particular structurally space-saving is achieved if the display element is partially or wholly integrated into the end element and therefore the surface of the display element requires only little additional structural space in comparison with the original surface of the end element, or it ends flush with a surface of the end element. In connection with an integrated reception of the display element in the end element, the latter can have a recess for this purpose, in which the display element is received in a dependably connected manner.

If the display element is arranged in or on the end element next to the switching element, which is integrated into the end element, the display element, as well as the switching element, can be mounted with less outlay and can be provided with common electrical connecting contacts.

In case of a one-piece connection of the display element with the switching element, such a combined element can be attached in a single mounting step to the end element. It is moreover possible for the display element to be electrically connected via an integrated electrical connection with the switching element and its connecting contacts.

If the switching element has been recessed in the end element of the front system, it is possible, in particular in case of a display element which is connected with the switching element, to achieve that the surface of the display element ends flush to a large degree with a surface of the end element, and therefore no additional structural space is required.

The lever pull handle of the invention has an end element for a front system with the features of claims 1 to 12. The display element is attached in a compact and space-saving manner to the end element of the lever pull handle.

The invention will be explained in greater detail by means of exemplary embodiments in the drawings. Shown are in:

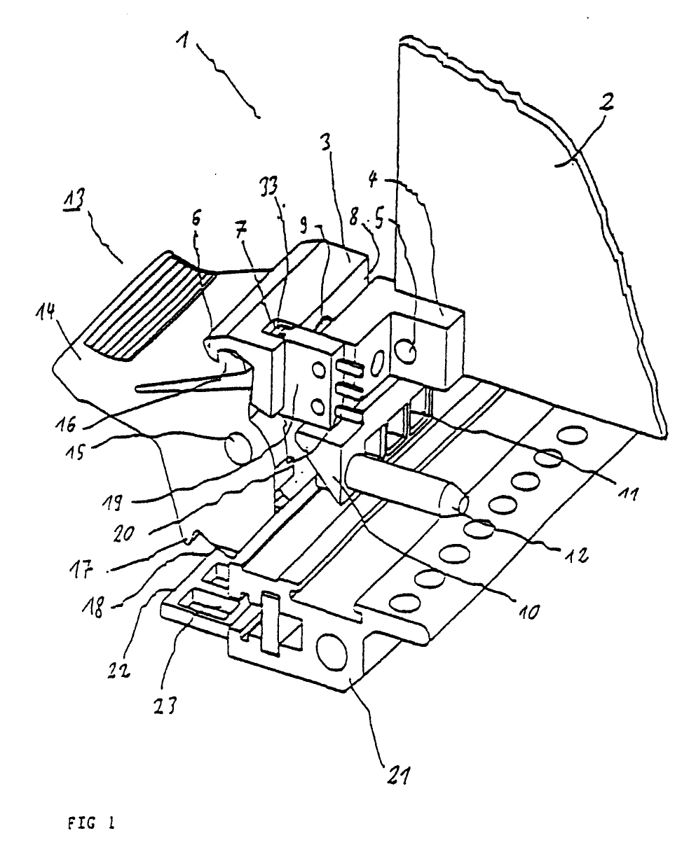

FIG. 1, a representation of a front system for a flat module in accordance with the prior art,

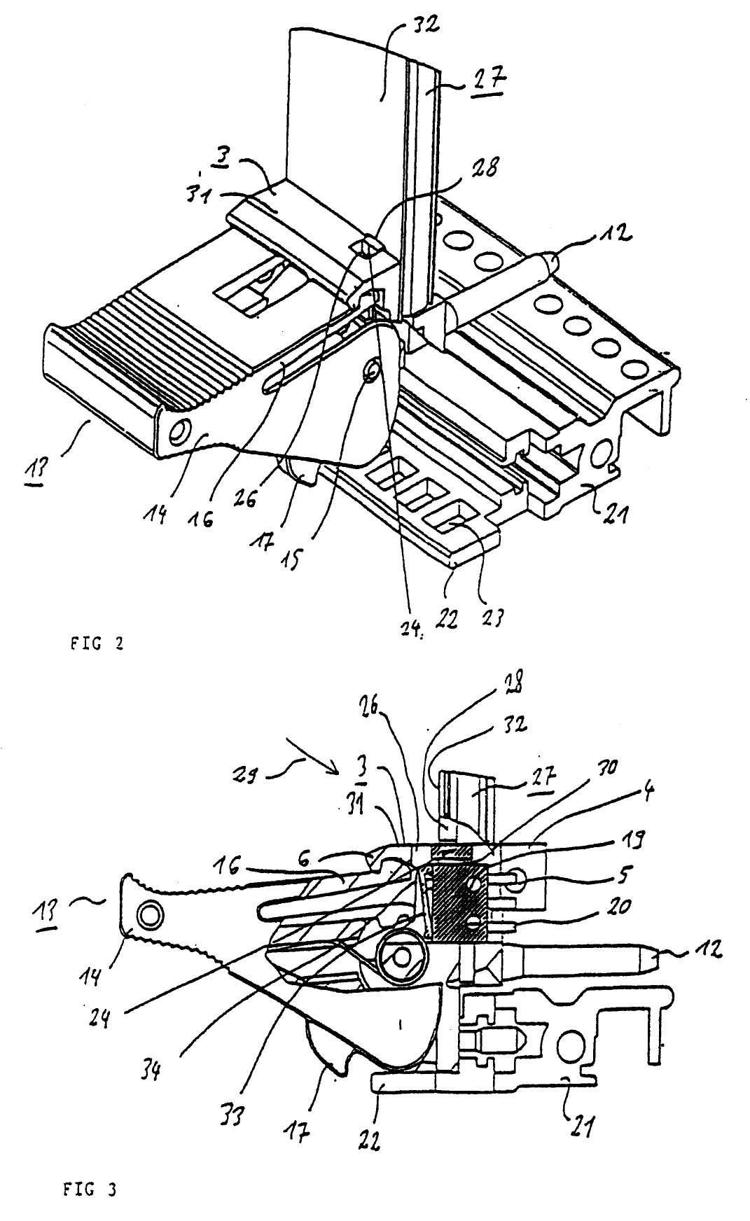

FIG. 2, a representation of a front system of the invention with an electrical display element in the end element, and

FIG. 3, a longitudinal section through the lever pull handle of the front system in FIG. 2.

A front system in accordance with the prior art for a flat module is shown in a perspective lateral view in FIG. 1. Here, the lower front end area 1 of such a front system for a flat module is represented and is partially shown in its form of a lower front end area 2. In this case the lower end area 1 rests on the lower transverse rail 21 of a component support, and here has a lower lever pull handle 13, a lower end element 3 and a front plate, not shown for reasons of clarity, as the main components. The lower end element here has a central supporting function since, for one, it is used as a support for the lever pull handle 13, which is rotatably seated by means of a bore pin 15. On the other hand, it can also be used for holding the lower end of the non-represented front plate, which to this end is advantageously pushed into a groove 8 and held in place by means of a screw engaging a bore 9. The connection between the lower end element 3 and the front lower corner of the flat module is preferably made via a support block 4 by means of a screw engaging a bore 5. Finally, still further components can be attached to such an end element 3. Thus, the end element 3 represented in FIG. 1 contains a coding block 10, in which coding chambers 11 for the insertion of coding pins, not represented, have been cut. These can engage coding chambers, which are attached opposite to the lower transverse rail 21 and are equipped with complementarily embodied coding pins. In this way it can be assured that only a defined selected flat module can be positioned in a plug-in location on a component support. Finally, there is a guide pin 12 which, after engagement with an oppositely located guide bore, not represented, assures a tilt-free correct insertion of the flat module.

The lower lever pull handle 13, which can be operated by actuating the handle element 14, is used for inserting or removing the flat module by leverage into or out of the corresponding plug-in location.

During levering-out, the lever pull handle 19 must be pushed downward, so that at least one levering-out projection 17 protruding from the underside can be supported on a front edge 22 of the lower transverse rail 21. In the reverse case, the lever pull handle 19 must be pushed upward during levering-in, so that at least one levering-in edge 18, which also protrudes from the underside, can be supported in the interior of at least one engagement indentation 23, which is also located in the area of the front edge 22 of the lower transverse rail 21.

Customarily means are also provided on the end element 3, by which the lever pull handle 13 is fixed in the appropriate position after attaining the state wherein the flat module is completely pushed into the component support. This inserted state is represented in FIG. 1.

To this end, the lever pull handle 13 advantageously has on its upper side a detent projection 16, which is oriented toward the end element 3, is resilient and projects upward and extends behind a downward extending detent edge 6 on the end element 3. In the same way, a corresponding arrangement consisting of an upper end element 3 with an upper lever pull handle 13 rotatably seated thereon is arranged on the front upper edge area 2, not represented in FIG. 1, of the flat module. It engages a corresponding upper transverse rail of a component support for levering-in and levering-out.

A switching element 19 is integrated into the lower or upper end element of the front system of the prior art in accordance with FIG. 1, and is actuated by means of the appropriate lever pull handle when the latter is in its fixed position. In this case it is possible to electrically clear the flat module, for example by activating its current supply. In the reverse manner it is also possible to switch the flat module electrically passive in that, at the time of levering-out the flat module, the engagement of the lever pull handle with the switching element 19 integrated into the end element 3 is also terminated, and the electrical current supply for the flat module is passivated again, for example by means of this release of the switching element 19.

A switching element 19, integrated into the lower end element 3, is shown by way of example in FIG. 1. It is seated in a receiving slit 7 extending as far as the area of the detent edge 6 of the end element 3. Thus a switching piece of the switching element 19, for example a switching lever 33, projects into the area below the downward extending detent edge 6 and is actuated when the fixed state of the lever pull handle 13 has been attained by the engagement of the rear (not visible) of the latter.

In the example of FIG. 1, this actuation can occur through the front end of the detent projection 16 facing the lower end element 3.

The integrated switching element 19 can be advantageously electrically connected with the flat module by means of a cable or cable plug connection, which can be attached to connecting contacts 20. However, other types of connection are also possible. Thus, the connecting contacts in the form of wires can be pulled down to the surface of the flat module, for example, and can be soldered into bores 5 or 9 provided there. The represented front system has the advantage that, by integrating the switching element 19 into a lower and an upper end element 3 of the front system of a flat module, the latter can be brought very exactly into an accurately definable position.

Thus, it is also possible to actuate the switching element 19 permanently dependably and wear-free by means of the lever pull handle 13, even if the switching means of the switching element 19 have only a very short switching path. Since the active-passive switching function is completely integrated into the front system, users of the front system are not subjected to limitations regarding the positioning of components on a flat module equipped with such a front system.

In particular, no dimensionally exact position requirements regarding electrical connections for the switching element 19 are required there.

While in the described front system of the prior art in accordance with FIG. 1 electrical display elements are received in a front plate, not represented for reasons of clarity, of the front system, which is inserted into a groove 8, the front system of the invention in accordance with FIGS. 2 and 3 has an electrical display element 24 in the end element 3 of the front system in accordance with the invention.

Here, the electrical display element 24 can be embodied as an LED element, for example, and indicate the switched state of a switching element 19 integrated into the switch of the front system of the invention. To the extent the structure of the front system of the invention in accordance with FIGS. 2 and 3 corresponds to the structure of the front system of the prior art in accordance with FIG. 1, identical reference numerals were used which, without any additional explanation, also have the functions represented by the drawing description in accordance with FIG. 1.

The display element 24 is received in the front system in accordance with FIG. 2 in a recess 26 of the end element 3, as well as in a recess 28 of the front plate 27, which has not been shown in the representation of FIG. I for reasons of clarity. Therefore such a display element 24, which is received recessed in such a way, does not require additional structural space in relation to the surface 31 of the end element 3 and the surface 32 of the front plate 27.

In the longitudinal sectional representation of the front system of the invention in FIG. 3, the arrangement of the display element 24 is described, in particular in respect to the switching element 29. Here, the display element 24 is attached next to and above the switching element 19, which is arranged in a recessed manner, and can be viewed by the user of the front system from the viewing direction 29. The display element 24 can be provided with current via the connecting contacts 20 of the switching element 19, or it can have a separate current supply with separate connecting contacts (not represented). Furthermore, the display element 24 can be connected in one piece and without a space 30 with the switching element 19 and, in the form of such a combined element, can be embodied to be particularly mounting-friendly (also not represented).

The actuation of the switching lever 33 of the switching element 19 by means of the back 34 of the detent protrusion 16 of the lever pull handle 13 in the fixed state of the latter can also be seen in FIG. 3. The switched state of this switching lever 33, and therefore the switched state of the switching element 19, can be indicated in accordance with the invention by means of the display element 24 being lit up or turned off.

In comparison with the switching system 19 in FIG. 1 in accordance with the prior art, the switching element 19 of the front system of the invention in accordance with FIGS. 2 and 3 is arranged recessed in the end element 3, so that the display element 24 can be arranged above the switching element 19 (see FIG. 3). The switching lever 33 of a switching element 19 arranged recessed in this way can, compared with the front system of the prior art in accordance with FIG. 1, be contacted and actuated by means of a rear 34 of the detent projection 16 of the lever pull handle 13, which has been appropriately extended downward—in the direction of the transverse support 21.

1. A front system for a flat module, which can be inserted into a component support, having
a) an upper or a lower end element (3) each arranged in the upper or lower front corner area (2) of the flat module,
b) an upper or lower lever pull handle (13) attached to the upper or lower end element (3) for inserting or removing the flat module into or out of the component support by leverage, which has means with which, when the flat module has reached the state wherein it is inserted into the component support, the respective lever pull handle (13) is fixed in place in the respective position, and with
c) a switching element (19), which is integrated into the upper or lower end element (3) in such a way that it is actuated by the respected lever pull handle (13) when the latter is in its fixed position,
characterized in that the upper or lower end element (3) has an electrical display element (24).

2. The front system in accordance with claim 1,
characterized in that the electrical display element (24) is attached to the exterior (25) of the end element (3).

3. The front system in accordance with claim 1 or 2,
characterized in that the display element (24) is partially integrated into the end element (3).

4. The front system in accordance with claim 1 or 2,
characterized in that the display element (24) is completely integrated into the end element (3).

5. The front system in accordance with one of the preceding claims,
characterized in that the end element (3) has a recess (26) for receiving the display element (24).

6. The front system in accordance with one of the preceding claims,
characterized in that the front plate (27) has a recess (28) for receiving the display element (24).

7. The front system in accordance with one of the preceding claims,
characterized in that the display element (24) is attached next to the switching element (19).

8. The front system in accordance with one of the preceding claims,
characterized in that the display element (24) is connected in one piece with switching element (19).

9. The front system in accordance with one of the preceding claims,
characterized in that the switching element (19) is recessed in the end element (3).

10. The front system in accordance with one of the preceding claims,
characterized in that the display element (24) has a separate current supply.

11. The front system in accordance with one of the preceding claims,
characterized in that the display element (24) is electrically connected with the switching element (19).

12. The front system in accordance with claim 11,
characterized in that the display element (24) is supplied with current via connecting contacts (20) of the switching element (19).

13. A lever pull handle (13) with an upper or lower end element (3) for a front system in accordance with one of claims 1 to 12.
